(19) United States
(12) Patent Application Publication
(10) Pub. No.: US 2014/0156174 A1
(43) Pub. Date: Jun. 5, 2014

(54) FUEL DISTRIBUTOR FOR DUAL-INJECTOR ENGINE AND METHOD OF CONTROLLING FUEL DISTRIBUTOR

(71) Applicant: Hyundai Motor Company, Seoul (KR)

(72) Inventors: Hyung Ju Lee, Seoul (KR); Ho Kyun Chun, Seoul (KR)

(73) Assignee: Hyundai Motor Company, Seoul (KR)

(21) Appl. No.: 13/955,361

(22) Filed: Jul. 31, 2013

(30) Foreign Application Priority Data
Dec. 5, 2012 (KR) 10-2012-0140416

(51) Int. Cl. F02D 7/00; F02M 41/00

(52) U.S. Cl. CPC F02D 7/00; F02M 41/00
USPC 701/105; 123/445

(57) ABSTRACT

A dual-injector engine for a dual-injector engine that includes at least two injectors disposed on at least two respective intake ports that communicate with a single combustion chamber. The at least two injectors are independently, asymmetrically and cooperatively operated to distribute the amounts of fuel injected from the injectors. Eventually, the fuel vaporability of a fuel and air mixture may be maximized. Thus, the combustion performance of the engine may be increased.

### CROSS-REFERENCE TO RELATED APPLICATION

This application claims priority to and the benefit of Korean Patent Application No. 10-2012-0140416 filed in the Korean Intellectual Property Office on Dec. 5, 2012, the entire contents of which are incorporated herein by reference.

### BACKGROUND

1. Field of the Invention

The present invention relates generally to a technique for controlling a dual-injector engine which uses two injectors to supply fuel into a combustion chamber and, more particularly, to an apparatus and method for distributing fuel to be injected by the two injectors.

2. Description of the Related Art

Typical engines have a single injector per intake port, and thus, the entire amount of fuel which is supplied into a corresponding combustion chamber is injected by the single injector. Meanwhile, to improve volumetric efficiency to enhance fuel efficiency and reduce harmful exhaust material, as shown in FIG. 1, a dual-injector engine is configured such that injectors 502 are respectively disposed on two intake ports 500 that communicate with a combustion chamber to supply fuel into the combustion chamber by controlling the two injectors 502. Therefore, in the dual-injector engine, the total amount of fuel to be injected into the single combustion chamber must be shared by the two injectors. To improve the volumetric efficiency and to maximize the effects of the fuel efficiency improvement, fuel must be injected when the intake valve opens.

FIG. 2 illustrates an exemplary injector driver of the conventional dual-injector engine according to the related art. An ECU (engine control unit) 504 includes a plurality of injector drivers 506, each of which controls two corresponding injectors 502 which are assigned to each combustion chamber. Therefore, in the injector driver having the above-mentioned construction, because the two injectors 502 that are assigned to each combustion chamber are operated by the single corresponding injector driver 506, the two injectors of each combustion chamber have the same injection time and pattern, although the two injectors of each combustion chamber may be controlled independently from the injectors of the other combustion chambers.

Meanwhile, fuels injected from the two injectors disposed on the respective intake ports flow differently, while entering the combustion chamber, depending on differences in the position and shape between the two intake ports.

It is to be understood that the foregoing description is provided to merely aid the understanding of the present invention, and does not mean that the present invention falls under the purview of the related art which was already known to those skilled in the art.

### SUMMARY

Accordingly, the present invention provides a fuel distributor for a dual-injector engine in which two injectors disposed on two respective intake ports that communicate with a single combustion chamber are independently, asymmetrically and cooperatively operated to distribute the amounts of fuel injected from the injectors, whereby the fuel vaporability of a fuel and air mixture may be increased, and the combustion performance of the engine may be increased.

According to one aspect, the present invention provides a fuel distributor for a dual-injector engine that may include: two injectors respectively disposed on two intake ports that communicate with a single combustion chamber; and injector drivers separately disposed to respectively operate the two injectors.

In another aspect, the present invention provides a method of controlling a fuel distributor for a dual-injector engine, including operating injector drivers connected to two injectors disposed on two intake ports that communicate with a combustion chamber to cause the two injectors to have different injection patterns during an intake stroke of the engine.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view showing an intake port portion of a conventional dual-injector engine according to the related art;

FIG. 2 is an exemplary view illustrating an injector driver of the conventional dual-injector engine according to the related art;

FIG. 3 is an exemplary view showing the construction of a fuel distributor for a dual-injector engine according to an exemplary embodiment of the present invention; and

FIG. 4 is an exemplary diagram showing a method of controlling the fuel distributor for the dual-injector engine according to an exemplary embodiment of the present invention.

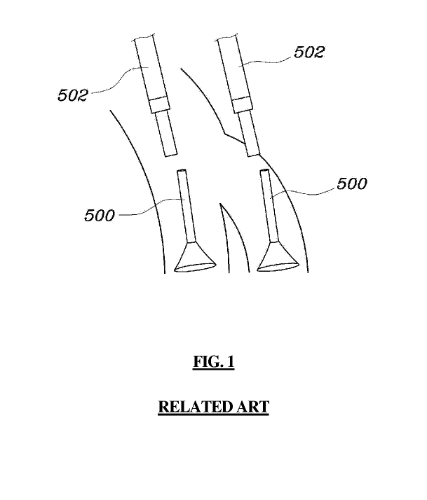

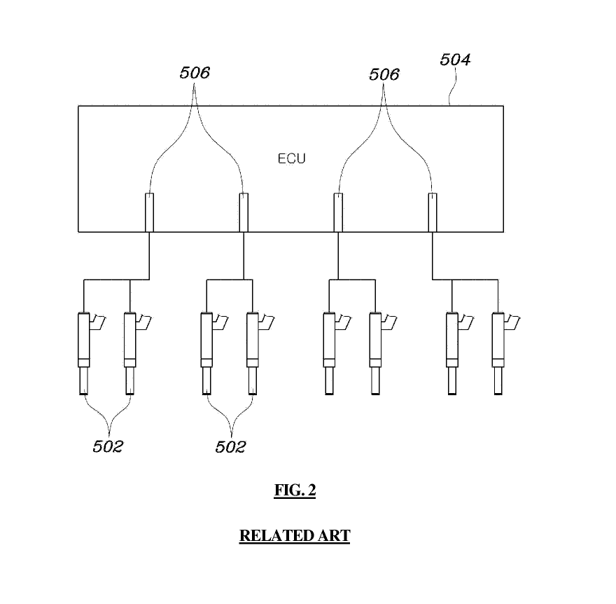

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

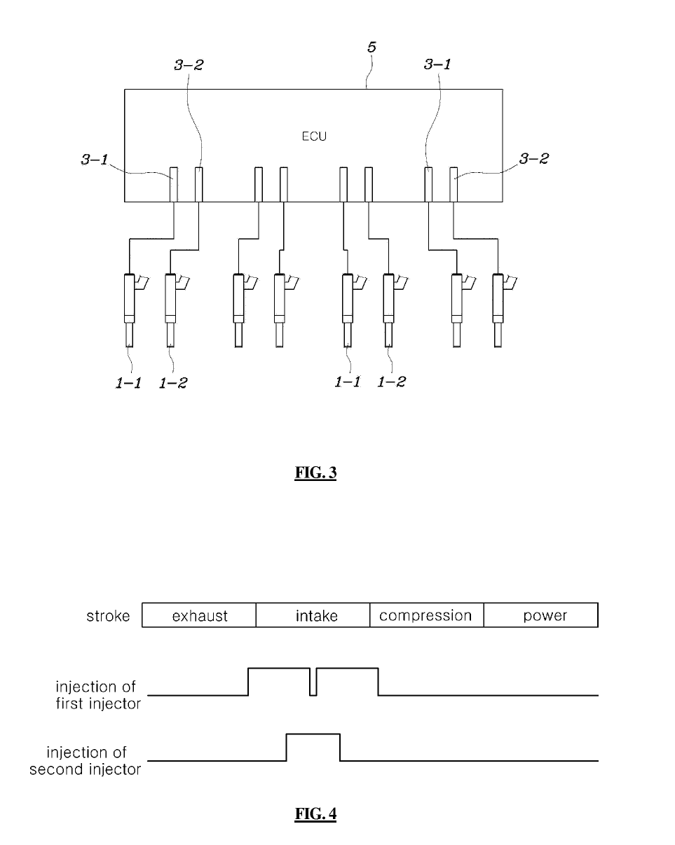

Hereinafter, exemplary embodiments of the present invention will be described in detail with reference to the accompanying drawings. Referring to FIG. 3, a fuel distributor for a dual-injector engine according to an exemplary embodiment of the present invention may include two injectors 1-1 and 1-2 which are respectively installed on two intake ports that communicate with a single combustion chamber, and injector drivers 3-1 and 3-2 which respectively drive the two injectors 1-1 and 1-2.

In the conventional technique, the single injector driver drives the two injectors which are respectively disposed on the two intake ports that communicate with the single combustion chamber, whereby the two injectors are synchronized to inject fuel rather than being independently operated. Therefore, the conventional technique cannot realize more active, subdivided and harmonious fuel injection. However, in the present invention the injectors 1-1 and 1-2 may be independently operated by the respective injector drivers 3-1 and 3-2. Therefore, the injectors 1-1 and 1-2 may inject fuel into the corresponding combustion chamber different injection times and during different injection durations. Therefore, the present invention may increase fuel vaporability of a mixture to operate the engine more efficiently.

Referring to FIG. 3, the injector drivers 3-1 and 3-2 may be disposed in an engine control unit 5 which controls the engine having the combustion chambers. The two injector drivers 3-1 and 3-2 may be provided for each of the combustion chambers of the engine to respectively control the two injectors 1-1 and 1-2 of the combustion chamber. The engine control unit 5 may be configured to individually operate the two injector drivers 301 and 302 which are assigned to each combustion chamber, whereby an injection time and an injection pattern of each injector 1-1, 1-2 may individually determine to independently inject fuel using the injectors 1-1 and 1-2, which are respectively connected to the injector drivers 3-1 and 3-2.

A method of controlling the fuel distributor of the dual-injector engine having the above-mentioned construction may include operating, by the engine control unit, the injector drivers 3-1 and 3-2 to inject fuel by the two corresponding injectors 1-1 and 1-2 disposed on the two intake port of each combustion chamber into the corresponding combustion chamber at different numbers of times during an intake stroke of the corresponding cylinder of the engine.

Alternatively, the method may include operating, by the engine control unit, the two corresponding injectors 1-1 and 1-2 disposed in the two intake port of each combustion chamber to have different injection durations during an intake stroke of the corresponding cylinder of the engine.

In other words, according to the method, the two injectors 1-1 and 1-2 disposed on the two respective intake ports that communicate with the corresponding combustion chamber may be independently operated during an intake stroke of the corresponding cylinder of the engine causing the injectors 1-1 and 1-2 to have different fuel injection times or different fuel injection durations and may inject a required amount of fuel into the corresponding combustion chamber in cooperation with each other within an opening period of an intake valve. Specifically, the purpose of the method is to control the injector drivers 3-1 and 3-2 to increase the fuel vaporization.

A combination of the number of injection times, the injection duration and the injection timing may be expressed as an injection pattern. The injectors may be respectively controlled by independent injection patterns and thus, during the opening period of the intake valve of the corresponding combustion chamber, fuel may be injected to optimize vaporization of the mixture.

For reference, FIG. 4 shows an example in which one of the two injectors injects fuel twice during an intake stroke, the other injector injects fuel once during the intake stroke, and the two injectors have different injection starting times and different injection durations. In this way, the dual injectors of the dual-injector engine may be more efficiently used. As a result, the performance of the engine may be enhanced.

As described above, in a dual-injector engine according to an exemplary embodiment of the present invention, two injectors disposed on two respective intake ports that communicate with a single combustion chamber may be independently, asymmetrically and cooperatively operated to distribute the amounts of fuel injected from the injectors. Eventually, the fuel vaporability of a fuel and air mixture may be maximized. Thus, the combustion performance of the engine may be increased.

Although the exemplary embodiments of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A fuel distributor for a dual-injector engine, comprising:
at least two injectors respectively disposed on at least two intake ports that communicate with a single combustion chamber; and
a plurality of injector drivers separately disposed to respectively operate the at least two injectors.

2. The fuel distributor as set forth in claim 1, wherein the injector drivers are disposed in an engine control unit configured to operate the engine having the combustion chamber, wherein the engine includes a plurality of combustion chambers, and at least two injector drivers are assigned to each of the combustion chambers.

3. The fuel distributor as set forth in claim 2, wherein the engine control unit individually operates the at least two injector drivers assigned to each of the combustion chambers and an injection time and an injection pattern of each of the injectors is individually determined to independently inject fuel using the injectors connected to the respective injector drivers.

4. The fuel distributor as set forth in claim 3, wherein one of the at least two injectors injects fuel twice during an intake stroke and the other of the at least two injectors injects fuel once during the intake stroke.

5. The fuel distributor as set forth in claim 4, wherein the at least two injectors have different injection starting times and different injection durations.

6. A method of controlling the fuel distributor for the dual-injector engine according to claim 1, comprising:
operating, by a controller, injector drivers connected to at least two injectors disposed on at least two intake ports that communicate with a combustion chamber to inject fuel into the combustion chamber different numbers of times during an intake stroke of the engine.

7. A method of controlling the fuel distributor for the dual-injector engine according to claim 1, comprising:
operating, by the controller, the plurality of injector drivers connected to the at least two injectors disposed on the at least two intake ports that communicate with a combustion chamber, wherein the at least two injectors have different injection durations during the intake stroke of the engine.

8. A method of controlling the fuel distributor for the dual-injector engine according to 1, comprising:
operating, by the controller, the injector drivers connected to the at least two injectors disposed on the at least two intake ports that communicate with a combustion chamber, wherein the at least two injectors have different injection patterns during the intake stroke of the engine.

9. The method of controlling the fuel distributor for the dual-injector engine according to claim 8, wherein one of the at least two injectors injects fuel twice during an intake stroke and the other of the at least two injectors injects fuel once during the intake stroke.

10. The method of controlling the fuel distributor for the dual-injector engine according to claim 9, wherein the at least two injectors have different injection starting times and different injection durations.
